(19) United States
(12) Patent Application Publication
(10) Pub. No.: US 2015/0129076 A1
(43) Pub. Date: May 14, 2015

(54) FUEL SUPPLY ROUTING ASSEMBLY FOR ENGINE TO DETECT FUEL LEAKAGE

(71) Applicant: Caterpillar Inc., Peoria, IL (US)

(72) Inventors: Ryan M. Snodgrass, Fowler, IN (US); Michael D. Gough, Lafayette, IN (US); Nicholas E. Wainscott, Rossville, IN (US); Oren P. Griffin, Lafayette, IN (US)

(73) Assignee: Caterpillar Inc., Peoria, IL (US)

(21) Appl. No.: 14/603,398

(22) Filed: Jan. 23, 2015

(51) Int. Cl. F02M 37/00; F16L 9/18

(52) U.S. Cl. CPC F02M 37/0017; F16L 9/18
USPC 138/109

(57) ABSTRACT

A tube assembly is disposed between a cylinder head of an engine and a fuel supply valve housing. The tube assembly includes a tube member, a first fitting member coupled to each end of the tube member, a second fitting member coupled to the first fitting member proximate to the fuel supply valve housing and a third fitting member coupled to the first fitting member proximate to the cylinder head. The tube member includes an inner tube configured to receive fuel therein and an outer tube disposed around the inner tube. The outer tube is communicably coupled to a leakage detection system. The first fitting member, the second fitting member and the second fitting member include respective passages that fluidly communicate with the inner tube and the outer tube of the tube member. Each of the second and third fitting members also includes radially spaced grooves at both faces.

### TECHNICAL FIELD

The present disclosure relates to a tube assembly for an engine, and in particular, to a tube assembly having a double walled tube.

### BACKGROUND

A fuel supply system of a gaseous fuel or a duel fuel internal combustion engine generally includes a double-walled fuel supply tube disposed between a fuel supply valve and an engine body. The double-walled fuel supply tube includes an inner tube for receiving a gaseous fuel. As the gaseous fuel flows through the inner tube, there may be possibilities that the gaseous fuel leaks out through the inner tube. An outer tube is provided around the inner tube to prevent leakage of the gaseous fuel out of the fuel supply system. Various types of leakage detection systems may also be fluidly connected to the outer tube.

However, during operation, the gaseous fuel may also leak from adjoining components (for example, the fuel supply valve) of the fuel supply tube. In such cases, the leaked fuel may escape to the ambient atmosphere. Further, the leakage detection system may be unable to detect such leakages.

For reference, GB Patent No. 2,324,845 discloses a joint for positioning between two sections of a double skinned pipeline including an inner pipe to contain a fluid at an elevated pressure and a sheathing pipe defining a space to contain a second gaseous fluid. The joint includes a pair of flanges and an interposable gasket both having aligned central apertures. The flanges include circumferentially arranged outer apertures and the gasket includes aligned slots. However, the joint does not include a seal located radially outwards of the outer apertures of the flanges and the slots of the gasket. Therefore, in case of leakage between the outer apertures and the slots, the fluid may flow out of the joint without any detection.

### SUMMARY OF THE DISCLOSURE

In an aspect of the present disclosure, a tube assembly is provided. The tube assembly is disposed between a cylinder head of an engine and a fuel supply valve housing. The tube assembly includes a tube member, a first fitting member, a second fitting member and a third fitting member. The tube member includes an inner tube structured to receive fuel therein and an outer tube disposed around the inner tube. The outer tube is communicably coupled to a leakage detection system.

The first fitting member is coupled to each end of the tube member. The first fitting member includes a first inner passage, a first outer passage and a first annular recess. The first inner passage extends between a first end and a second end of the first fitting member. The first outer passage is in fluid communication with the outer tube of the tube member at the first end of the first fitting member. The first annular recess is defined in the second end of the first fitting member. Further, the first annular recess is disposed in fluid communication with the first fitting member.

The second fitting member is coupled with the first fitting member proximate to the fuel supply valve housing. The second fitting member has a first face interfacing with the second end of the first fitting member and a second face interfacing with the fuel supply valve housing. The second fitting member includes a second inner passage, a pair of grooves disposed on each of the first face and second face of the second fitting member, a second outer passage and a second annular recess. The second inner passage extends between the first face and the second face. The second inner passage is disposed in fluid communication with the first inner passage of the first fitting member and a supply passage of the fuel supply valve housing. Further, each groove of the pair of grooves is radially spaced from the other. A sealing member is received within each groove of the pair of grooves disposed on each of the first face and the second face of the second fitting member. The second outer passage is disposed in fluid communication with the first annular recess of the first fitting member and extends from the first face of the second fitting member. The second outer passage is radially disposed between each groove of the pair of grooves defined on the first face of the second fitting member. The second annular recess is defined on the second face of the second fitting member and disposed in fluid communication the second outer passage. The second annular recess is radially disposed between each groove of the pair of grooves defined on the second face of the second fitting member.

The third fitting member is coupled with the first fitting member proximate to the cylinder head of the engine. The third fitting member has a first face interfacing with the second end of the first fitting member and a second face interfacing with the cylinder head. The third fitting member includes a third inner passage, a pair of grooves disposed on each of the first face and the second face, and a channel. The third inner passage extends from the first face to the second face of the third fitting member. The third inner passage is disposed in fluid communication with the first inner passage of the first fitting member and the cylinder head of the engine. Moreover, each groove of the pair grooves is radially spaced from the other. A sealing member is received within each groove of the pair of grooves disposed on each of the first face and the second face of the third fitting member. The channel is disposed in fluid communication with first outer passage of the first fitting member and extends from the first face of the third fitting member to the second face of the third fitting member. The channel is radially disposed between each groove of the pair of grooves disposed on each of the first face and the second face of the third fitting member. Other features and aspects of this disclosure will be apparent from the following description and the accompanying drawings.

### BRIEF DESCRIPTION OF THE DRAWINGS

FIG. 1 illustrates a perspective view of a fuel supply system of an engine, according to an embodiment of the present disclosure;

FIG. 2 illustrates a sectional view of a tube assembly of the fuel supply system of FIG. 1, according to an embodiment of the present disclosure;

FIG. 3 illustrates a detailed sectional view of a first end of the tube assembly of FIG. 2;

FIG. 4 illustrates a partial sectional perspective view of a first fitting member of the tube assembly of FIG. 2, according to an embodiment of the present disclosure; and

FIG. 5 illustrates a detailed sectional view of a second end of the tube assembly of FIG. 2.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts.

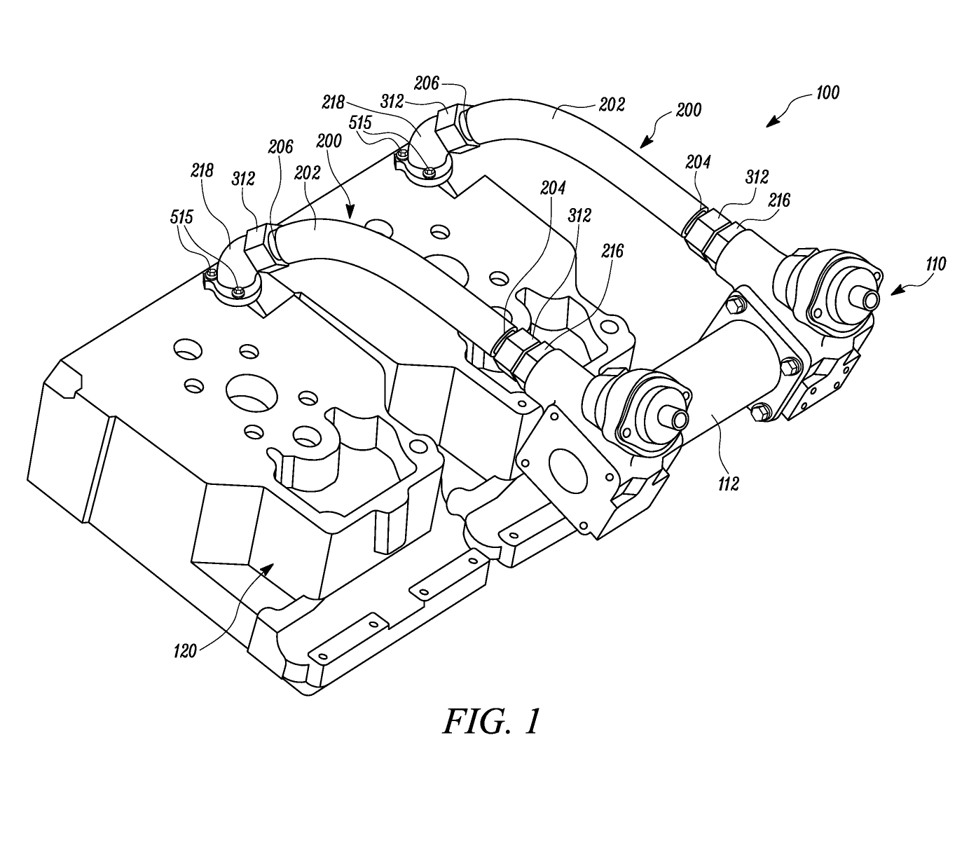

FIG. 1 shows a perspective view of a fuel supply system 100 of an engine, according to an embodiment of the present disclosure. The engine may be a gaseous fuel engine or a dual fuel engine. The engine may power various types of machines associated with an industry, including power generation, transportation, construction, mining, agriculture, forestry, marine applications, waste management, material handling, and the like.

The fuel supply system 100 includes a gas rail 112 fluidly connected to multiple fuel supply valve housings 110 (hereinafter referred to as “the valve housings 110”). The gas rail 112 may be configured to receive a gaseous fuel (for example, natural gas) from a fuel source. Further, a tube assembly 200 is disposed between each of the fuel supply valve housings 110 and a cylinder head 120 of the engine. The cylinder head 120 of the engine may be assembled on a cylinder block (not shown) of the engine. In the illustrated embodiment, the engine includes multiple cylinders defined in the cylinder block. The cylinder head 120 may define passages to allow the gaseous fuel to flow from the tube assembly 200 to the respective cylinders.

Each of the tube assemblies 200 and the valve housings 110 is structured and arranged to supply the gaseous fuel to a corresponding cylinder. The number of tube assemblies 200 and valve housings 110, as shown in FIG. 1, is exemplary in nature and the number may vary as per the number of cylinders in the engine.

Each of the valve housing 110 may include a gas admission valve (not shown) configured to regulate a flow of the gaseous fuel from the gas rail 112 to the tube assembly 200. The gas admission valve may be controlled by an ECM (Electronic control Module) (not shown) programmed to regulate the gas admission valve as per fuel requirements of the engine.

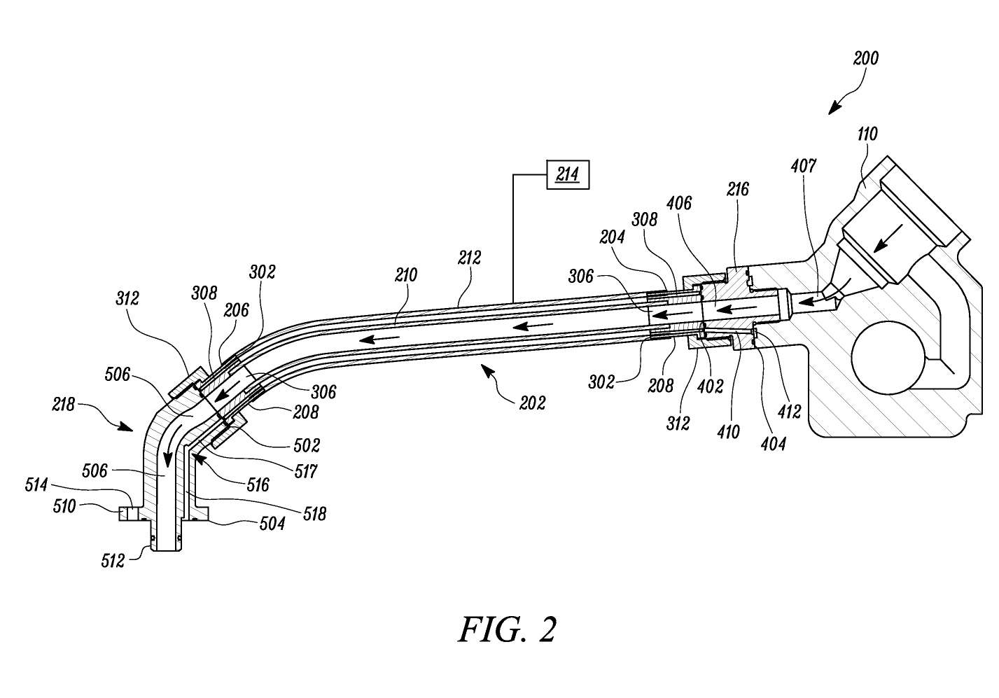

FIG. 2 illustrates a perspective view of the tube assembly 200, according to embodiment of the present disclosure. Reference may also be made to FIG. 1 to describe one or more components of the tube assembly 200. The tube assembly 200 includes a tube member 202 having a first end 204 and a second end 206, and a first fitting member 208 coupled to each of the first and second ends 204, 206 of the tube member 202. The tube member 202 may be a flexible or a rigid tube. The first fitting members 208 may be coupled to the tube member 202 by various methods, such as welding, press-fitting, adhesives, and the like. The tube member 202 includes an inner tube 210 and an outer tube 212. The inner tube 210 is configured to receive the gaseous fuel from the gas admission valve. The outer tube 212 is disposed around the inner tube 210 and is communicably coupled to a leakage detection system 214. In the illustrated embodiment, the tube member 202 has a curvilinear shape. However, the curvilinear shape is exemplary in nature and the tube member 202 may have any alternative shape as per requirements.

The leakage detection system 214 is shown schematically in FIG. 2 and is configured to detect leakage of the gaseous fuel to the outer tube 212. In an embodiment, the leakage detection system 214 may include an inert gas source configured to supply the outer tube 212 with pressurized inert gas and a pressure sensor configured to detect pressure within the outer tube 212. The pressure of the inert gas may be higher than the pressure of the gaseous fuel. In case of leakage, the pressure inside the outer tube 212 may drop. This pressure drop may be detected by the leakage detection system 214. In an alternative embodiment, the leakage detection system 214 includes a gas sensor configured to detect presence of the gaseous fuel within the outer tube 212 and a vacuum pump in fluid communication with the outer tube 212. Further, air is supplied to the outer tube 212. A pressure of the air may be lower than the pressure of the gaseous fuel. In case of leakage, the gas sensor may detect presence of the gaseous fuel in the outer tube 212. The vacuum pump may then remove air along with the leaked gaseous fuel from the outer tube 212. The leakage detection system 214 may also generate an alarm on detection of leakage. Further, the leakage detection system 214 may also control an operation of the engine based on detection of leakage. In an embodiment, an additional purging operation may also be performed to remove any leaked fuel from the tube assembly 200.

The tube assembly 200 further includes a second fitting member 216 coupled to the first fitting member 208 proximate to the valve housing 110. Specifically, the second fitting member 216 is coupled to the first fitting member 208 disposed at the first end 204 of the tube member 202. The second fitting member 216 is fluidly disposed between the gas admission valve and the first fitting member 208. The tube assembly 200 also includes a third fitting member 218 coupled to the first fitting member 208 proximate to the cylinder head 120 of the engine. Specifically, the third fitting member 218 is coupled to the first fitting member 208 disposed at the second end 206 of the tube member 202.

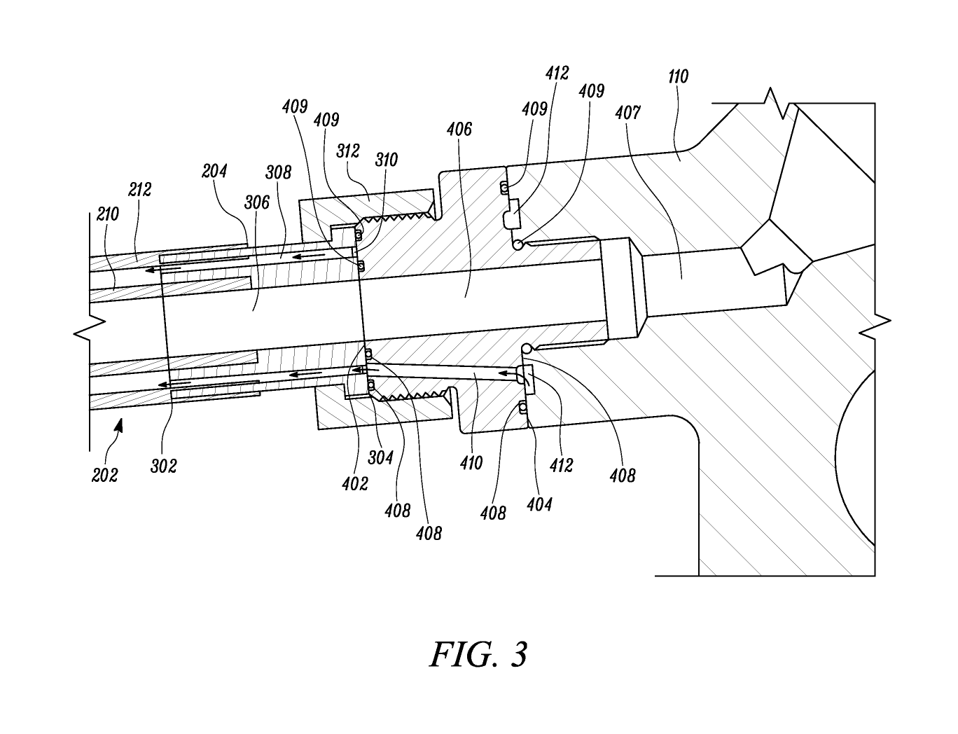

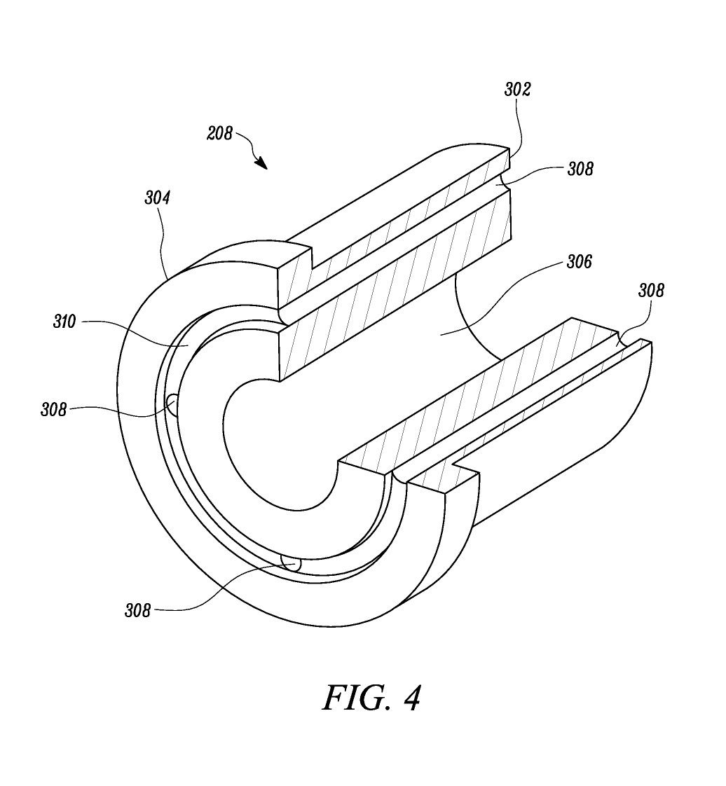

Referring to FIGS. 3 and 4, the first fitting member 208 includes a first end 302 adjacent to the tube member 202 and a second end 304 distal to the tube member 202. The first fitting member 208 defines a first inner passage 306, multiple first outer passages 308, and a first annular recess 310. The first inner passage 306 extends between the first end 302 and the second end 304 of the first fitting member 208. Further, the first inner passage 306 is disposed in fluid communication with the inner tube 210 of the tube member 202 at the first end 302. Each of the first outer passages 308 is disposed in fluid communication with the outer tube 212 of the tube member 202. Further, the first outer passages 308 may be angularly spaced within the first fitting member 208. Though four such first outer passages 308 are illustrated in FIG. 4, it may be contemplated that that any suitable number of first outer passages 308 may be provided. The first annular recess 310 is defined in the second end 304 of the first fitting member 208. Further, the first annular recess 310 is disposed in fluid communication with the first outer passages 308. In an example, the first outer passages 308 may be drilled within the first fitting member 208.

Further, the first fitting member 208 is coupled to the second fitting member 216 by a fastening member 312. In the illustrated embodiment, the fastening member 312 is a threaded nut. The fastening member 312 may be coupled to the first fitting member 208 by various methods, such as welding, press-fitting, adhesives, and the like. In an example, the first fitting member 208 may include a lip portion on an outer surface thereof. The lip portion may be coupled with a corresponding shoulder portion provided on an inner surface of the fastening member 312 by a clearance fit. Further, the fastening member 312 includes internal threads configured to engage with external threads of the second fitting member 216. The second fitting member 216 may be coupled to the valve housing 110 via threads. The second fitting member 216 includes a first face 402 interfacing with the second end 304 of the first fitting member 208, and a second face 404 interfacing with the valve housing 110. Further, the second fitting member 216 includes a second inner passage 406 extending between the first face 402 and the second face 404. Further, the second inner passage 406 is disposed in fluid communication with the first inner passage 306 of the first fitting member 208 and a supply passage 407 of the valve housing 110. The supply passage 407 may be in fluid communication with the gas admission valve.

The second fitting member 216 also includes a pair of grooves 408 disposed on each of the first face 402 and the second face 404. Each groove 408 is radially spaced from the other groove 408 at each of the first face 402 and the second face 404. Further, each of the grooves 408 is configured to receive a sealing member 409 therein. In the illustrated embodiment, the sealing members 409 are O-rings.

As best shown in FIG. 3 the second fitting member 216 further includes a second outer passage 410 and a second annular recess 412. The second outer passage 410 is disposed in fluid communication with the first annular recess 310 of the first fitting member 208 and extends from the first face 402. The second outer passage 410 is radially disposed between each of the pair of grooves 408 disposed on the first face 402. In an example, the second outer passage 410 may be formed by drilling within the second fitting member 216. The second annular recess 412 is defined on the second face 404 and disposed in fluid communication with the second outer passage 410. The second annular recess 412 is radially disposed between each of the pair of grooves 408 disposed on the second face 404.

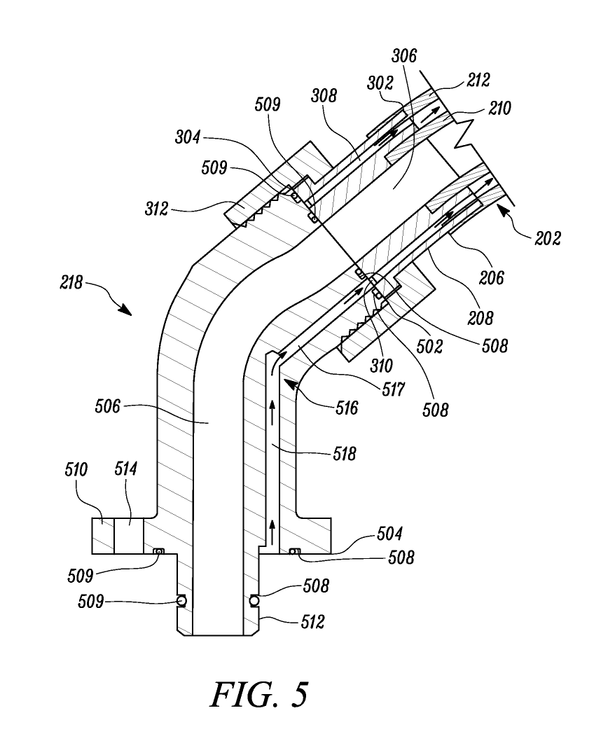

As shown in FIG. 5, the first fitting member 208 at the second end 206 of the tube member 202 may be substantially identical to the first fitting member 208 at the first end 204 of the tube member 202. Hence, the first fitting member 208 at the second end 206 also includes the first inner passage 306, the first outer passages 308 and the first annular recess 310. Further, the fastening member 312 couples the first fitting member 208 to the third fitting member 218 in a manner similar to the first fitting member 208 and the second fitting member 216.

The third fitting member 218 includes a first face 502 interfacing with the second end 304 of the first fitting member 208 and a second face 504 interfacing with the cylinder head 120. The third fitting member 218 includes a third inner passage 506 extending between the first face 502 and the second face 504 of the third fitting member 218. The third inner passage 506 is disposed in fluid communication with the first inner passage 306 of the first fitting member 208. In the illustrated embodiment, the third fitting member 218 is an elbow connector having a curvilinear shape. Hence, the third inner passage 506 also has a curvilinear shape. The curvilinear shape enables the third fitting member 218 to interface with the first fitting member 208 and the cylinder head 120.

The third fitting member 218 further includes a pair of grooves 508 disposed on each of the first face 502 and the second face 504 of the third fitting member 218. Each groove 508 is radially spaced from the other groove 508 at each of the first face 502 and the second face 504. Further, each of the grooves 508 is configured to receive a sealing member 509 therein. In the illustrated embodiment, the sealing members 509 are O-rings. As illustrated in FIG. 5, the second face 504 of the third fitting member 218 includes a flange portion 510 and a projecting portion 512. The flange portion 510 extends radially outwards from the projecting portion 512 and defines a plurality of apertures 514 (one shown in FIG. 5). Each of the plurality of apertures 514 are configured to receive bolts 515 (shown in FIG. 1) therein to couple the third fitting member 218 to the cylinder head 120. The projecting portion 512 extends into the cylinder head 120. The third inner passage 506 passes through the projecting portion 512. One of the grooves 508 are defined on the flange portion 510, while the other groove 508 is defined on the projecting portion 512. In an embodiment, in the assembled configuration, a space between the grooves 508 may cooperate with a undercut portion (not shown) of the cylinder head 120 to define an annulus therebetween.

The third fitting member 218 further includes a channel 516. The channel 516 further includes a first channel portion 517 and a second channel portion 518. The first channel portion 517 is disposed in fluid communication with the first outer passage 308 of the first fitting member 208 and extending from the first face 502 of the third fitting member 218. The first channel portion 517 is radially disposed between the grooves 508 disposed on the first face 502. The second channel portion 518 is disposed in fluid communication with the first channel portion 517 and extends to the second face 504 of the third fitting member 218. The second channel portion 518 is inclined with respect to the first channel portion 517. In an alternate embodiment the first channel portion 517 and the second channel portion 518 may be collinear such that the channel 516 may have a substantially linear shape. Further, the second channel portion 518 is radially disposed between the grooves 508 disposed on the second face 504. In an embodiment, the first and second channels portions 517, 518 may be formed by drilling.

### INDUSTRIAL APPLICABILITY

The present invention relates to the tube assembly 200 including the tube member 202, the first fittings 208, the second fitting 216, the third fitting 218 and the sealing members 409, 509. The tube assembly 200 is disposed between the valve housing 110 and the cylinder head 120 of the engine.

During operation of the engine, the gaseous fuel supplied by the gas admission valve flows (as indicated by the arrows in FIG. 2) through the supply passage 407, the second inner passage 406, the first inner passages 306, the inner tube 210 and the third inner passage 506. In case of any leakage of the gaseous fuel from the inner tube 210 to the outer tube 212, the leakage detection system 214 may detect the leakage as described above. Referring to FIGS. 3 and 5, the sealing member 409, 509 located radially inwards on the second and third fitting member 216, 218, respectively, may prevent any leakage of the gaseous fuel from interfaces between the various components.

Referring to FIGS. 3 to 4, in case of leakage of the gaseous fuel from the valve housing 110, the gaseous fuel may accumulate in the second annular recess 412 of the second fitting member 216. The sealing members 409 located radially outwards on the second face 404 of the second fitting member 216 may prevent leakage of the gaseous fuel from the second annular recess 412. Further, the gaseous fuel from the second annular recess 412 flows (indicated by the arrows) through the second outer passage 410 to the first annular recess 310 of the first fitting member 208. The sealing members 409 located radially outwards on the first face 402 of the second fitting member 216 may prevent leakage of the gaseous fuel from the first annular recess 310. The gaseous fuel then flows through the first outer passages 308 to the outer tube 212. The leakage detection system 214 may detect presence of the gaseous fuel in the outer tube 212.

Referring to FIGS. 1, 4 and 5, in case of leakage of the gaseous fuel from the cylinder head 120, the gaseous fuel may accumulate in the annulus defined between the undercut portion of the cylinder head 120 and the third fitting member 218. The sealing members 509 disposed on the flange portion 510 of the third fitting member 218 may prevent leakage of the gaseous fuel from the annulus. Further, the gaseous fuel from the annulus flows (indicated by the arrows in FIG. 5) through the first and second channels 517, 518 to the first annular recess 310 of the first fitting member 208. The sealing members 509 located radially outwards on the first face 502 of the third fitting member 218 may prevent leakage of the gaseous fuel from the first annular recess 310. The gaseous fuel then flows through the first outer passages 308 to the outer tube 212. The leakage detection system 214 may detect presence of the gaseous fuel in the outer tube 212.

As described above, the tube assembly 200 enables detection of leakage of the gaseous fuel at the first and second ends 204, 206 of the tube member 202, and specifically within the valve housings 110 and the cylinder head 120. Further, any leakage of the gaseous fuel is also prevented by the sealing members 409, 509.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A tube assembly disposed between a cylinder head of an engine and a fuel supply valve housing, the tube assembly comprising:
a tube member comprising an inner tube structured and arranged to receive fuel therein and an outer tube disposed around the inner tube, wherein the outer tube is communicably coupled to a leakage detection system;
a first fitting member coupled to each end of the tube member, the first fitting member comprising:
a first inner passage extending between a first end and a second end of the first fitting member, wherein the first inner passage is disposed in fluid communication with the inner tube of the tube member at the first end;
a first outer passage in fluid communication with the outer tube of the tube member at the first end of the first fitting member; and
a first annular recess defined in the second end of the first fitting member, wherein the first annular recess is disposed in fluid communication with the first outer passage;
a second fitting member coupled with the first fitting member proximate to the fuel supply valve housing, the second fitting member having a first face interfacing with the second end of the first fitting member and a second face interfacing with the fuel supply valve housing, the second fitting member comprising:
a second inner passage extending between the first face and the second face, wherein the second inner passage is disposed in fluid communication with the first inner passage of the first fitting member and a supply passage of the fuel supply valve housing;
a pair of grooves disposed on each of the first face and the second face of the second fitting member, wherein each groove of the pair of grooves is radially spaced from the other;
a second outer passage disposed in fluid communication with the first annular recess of the first fitting member and extending from the first face of the second fitting member, wherein the second outer passage is radially disposed between each groove of the pair of grooves disposed on the first face of the second fitting member; and
a second annular recess defined on the second face of the second fitting member and disposed in fluid communication with the second outer passage, wherein the second annular recess is radially disposed between each groove of the pair of grooves disposed on the second face of the second fitting member;
a sealing member received within each groove of the pair of grooves disposed on each of the first face and the second face of the second fitting member;
a third fitting member coupled with the first fitting member proximate to the cylinder head of the engine, the third fitting member having a first face interfacing with the second end of the first fitting member and a second face interfacing with the cylinder head, the third fitting member comprising:
a third inner passage extending from the first face and to the second face of the third fitting member, wherein the third inner passage is disposed in fluid communication with the first inner passage of the first fitting member and the cylinder head;
a pair of grooves disposed on each of the first face and the second face of the third fitting member, wherein each groove of the pair of grooves is radially spaced from the other; and
a channel disposed in fluid communication with the first outer passage of the first fitting member and extending from the first face of the third fitting member to the second face of the third fitting member, wherein the first channel is radially disposed between each groove of the pair of grooves disposed on each of the first face and the second face of the third fitting member; and
a sealing member received within each groove of the pair of grooves disposed on each of the first face and the second face of the third fitting member.
